(19) United States
(12) Patent Application Publication
(10) Pub. No.: US 2026/0308066 A1
(43) Pub. Date: Oct. 8, 2026

(54) METHOD FOR PREPARING POROUS CERAMIC WITH UNIFORM MICRO-NANO PORES

(71) Applicant: Central South University, Changsha (CN)

(72) Inventors: Yanxiu WANG, Changsha (CN); Wei SUN, Changsha (CN); Li WANG, Changsha (CN); Xiangyang XU, Changsha (CN); Fan WANG, Changsha (CN); Chengwen WANG, Changsha (CN); Zhiguang LU, Changsha (CN); Xudong WANG, Changsha (CN); Ziqiang LIU, Changsha (CN); Liang ZHANG, Changsha (CN)

(73) Assignee: Central South University, Changsha (CN)

(21) Appl. No.: 19/281,810

(22) Filed: Jul. 28, 2025

(30) Foreign Application Priority Data
Mar. 4, 2025 (CN) 202510245743.3

(51) Int. Cl. C04B 35/14; C04B 35/622; C04B 35/624; C04B 35/626; C04B 35/634; C04B 35/636; C04B 35/64; C04B 38/00; C04B 38/10; B28B 1/24

(52) U.S. Cl. CPC C04B 35/14; C04B 35/62204; C04B 35/624; C04B 35/62655; C04B 35/62675; C04B 35/6269; C04B 35/63416; C04B 35/63424; C04B 35/6365; C04B 35/64; C04B 38/0045; C04B 38/0054; C04B 38/10; B28B 1/24; C04B 2235/3217; C04B 2235/3418; C04B 2235/6022; C04B 2235/606; C04B 2235/6567

(57) ABSTRACT

A method for preparing a porous ceramic with uniform micro-nano pores is provided. The method includes: mixing a gelling agent, a surfactant, and water while stirring to produce a homogeneous solution; feeding the homogeneous solution into a micro-nano bubble generator to produce a micro-nano gel foam; adding a mineral powder and a curing agent, and stirring at a high speed; and conducting injection molding, curing, demolding, drying, and sintering in sequence to produce the porous ceramic.

### CROSS REFERENCE TO THE RELATED APPLICATIONS

This application is based upon and claims priority to Chinese Patent Application No. 202510245743.3, filed on Mar. 4, 2025, the entire contents of which are incorporated herein by reference.

### TECHNICAL FIELD

The present disclosure relates to a method for preparing a ceramic material, specifically a method for preparing a porous ceramic with a uniform micro-nano pore structure, and belongs to the technical field of porous ceramics.

### BACKGROUND

Porous ceramics, as lightweight materials, exhibit characteristics such as large specific surface area, high permeability, low density, and excellent thermal insulation performance. Thus, the porous ceramics play a significant role in catalyst supports, biomaterials, insulation systems, heat exchange, and other related fields. Currently, one of the popular strategies for preparing the porous ceramics with slurries is mainly as follows: an external gas phase is introduced into a system through mechanical stirring, a surfactant or a colloid mineral is located at a gas-liquid interface to stabilize the gas phase, and other additives are then used to cure a foam slurry. There are significant challenges in preparing fine-structured and lightweight porous foamed ceramics through a conventional mechanical slurry stirring method. A size of bubbles in a foam slurry plays a crucial role in reducing a pore size of a sintered sample. Chinese patent with publication No. CN101967064A discloses a method for preparing a bulk photocatalytic material through foaming with egg white as a foaming agent. However, in this method, a large amount of the egg white with low solubility is used. As a result, a foam slurry will be highly viscous, and it is difficult to disperse fine bubbles in large quantities. Chinese patent with publication No. CN101941231A discloses a silicon nitride whisker/silicon carbide porous ceramic and a preparation method thereof. In this patent, an organic monomer and a crosslinking agent are adopted as gelling agents for foam stabilization and green body solidification. In this preparation method, a slurry needs to be degassed under a vacuum degree of 6 × 10⁻² Pa, and the presence of oxygen could suppress polymerization. These factors increase complexity of a preparation process. Chinese patent with publication No. CN103145444B discloses a low-cost preparation method of a heat-insulating and lightweight porous mullite ceramic. In this preparation method, sodium dodecyl sulfate, a cationic surfactant, is adopted as a foaming agent for a mullite powder under a condition of solid content to prepare the porous mullite ceramic. In this preparation method, the foaming agent tends to undergo electrostatic repulsion with a negatively-charged surface of the mullite powder, which easily causes desorption during low-temperature drying and makes a foam layer unstable. The prepared porous mullite ceramic has a pore size of about 200 μm to 500 μm.

In summary, current processes for preparing porous ceramic materials with foam slurries all are faced with issues such as low foam stability, high foaming agent consumption, large pore size, and large process complexity.

### SUMMARY

In view of the technical shortcomings of the existing process for preparing a porous ceramic material with a foam slurry, an object of the present disclosure is to provide a method for preparing a porous ceramic with uniform micro-nano pores. In this method, a saturated and stable slurry-gel foam is prepared by a micro-nano bubble generator through high-pressure aeration and high-speed and high-intensity shearing, so as to produce a porous ceramic material with fine and uniform pores, a low weight, and a high compressive strength. This method overcomes a limitation that the existing slurry foaming process requires high surfactant consumption and results in small porosity due to a high solid content. Therefore, the method reduces the surfactant consumption, involves a simple process flow that is easy to implement, and meets the needs of industrial production.

In order to achieve the above technical object, the present disclosure provides a method for preparing a porous ceramic with uniform micro-nano pores, including the following steps:
1) mixing a gelling agent, a surfactant, and water while stirring to produce a homogeneous solution;
2) feeding the homogeneous solution into a micro-nano bubble generator, subjecting the homogeneous solution to circularly flow under aeration, and conducting ejection to produce a micro-nano gel foam, where a rate of the circular flow is 2 liters/minute to 20 liters/minute, and the aeration is conducted for 5 minutes to 10 minutes with a gas flow rate of 100 millilitres/minute to 250 millilitres/minute;
3) adding a mineral powder to the micro-nano gel foam, and stirring for 10 minutes to 30 minutes at a high speed of 1,000 revolutions/minute to 1,400 revolutions/minute to produce a slurry-gel foam, and adding a curing agent to the slurry-gel foam, and stirring for 15 minutes to 30 minutes at a high speed of 1,000 revolutions/minute to 1,400 revolutions/minute to produce a stabilized slurry-gel foam; and
4) subjecting the stabilized slurry-gel foam to injection molding, curing, demolding, drying, and sintering in sequence to produce the porous ceramic.

In the existing slurry foaming technologies, generation of bubbles primarily relies on air shearing. Because air has relatively low solubility, it is typically difficult to achieve generation of micro-nano bubbles in the natural environment. The key of the present disclosure lies in use of a micro-nano bubble generator to produce a micro-nano gel foam and use of a high-speed shearing technology to achieve mixing of a mineral powder with the micro-nano gel foam, which could enhance uniform dispersion of micro-nano bubbles in a high-viscosity slurry to produce a stabilized slurry-gel foam. Specifically, a homogeneous solution including a gelling agent and a surfactant is fed into a micro-nano bubble generator. Under an action of a gas pressure, a gas-liquid mixture undergoes ultra-high-speed rotation and then is ejected through a nozzle, such that high-speed and high-intensity shearing and high-frequent pressure fluctuations occur at a gas-liquid interface to produce a micro-nano gel foam under artificially extreme conditions, which makes a gas supersaturated in the micro-nano gel foam. Under an shearing action of high-speed stirring, a mineral powder and a curing agent are added. While the mineral powder is thoroughly mixed with the micro-nano gel foam, under a rapid curing action of the curing agent, micro-nano bubbles could be stably and uniformly dispersed in a slurry before aggregating, growing, or dissipating until curing molding. As a result, pores in a porous ceramic could be further refined and homogenized to produce a porous ceramic material with fine and uniform pores, a low weight, and a high compressive strength.

An innovative aspect of the present disclosure is as follows: A slurry-gel foam in which micro-nano bubbles are uniformly dispersed is first prepared with a gelling agent, a surfactant, and a mineral powder, and then a curing agent is introduced for stabilization. If the curing agent is introduced too early, a gelling effect of the micro-nano foam will be affected, and thus it is difficult to form a uniform and stable gel network, which leads to uneven pore wall thicknesses, is not conducive to the molding of a porous ceramic green body, and significantly reduces the strength of the porous ceramic. When the slurry-gel foam is first prepared and then the curing agent is introduced, under the rapid curing action of the curing agent, the micro-nano bubbles could be stably and uniformly dispersed in the slurry before the aggregating, the growing, or the dissipating until the curing molding. As a result, the porous ceramic material with the fine and uniform pores, the low weight, and the high compressive strength could be produced.

In some embodiments, the surfactant includes at least one selected from the group consisting of sodium dodecyl sulfonate, dodecylamine, cetyltrimethylammonium bromide, and a plant protein. In some embodiments of the present disclosure, the plant protein is further a tea saponin or a triterpenoid saponin from Sapindus mukorossi. The surfactant adopted in the present disclosure is a commercially-available industrial-grade or analytical-grade product. The surfactant is a conventional surfactant adopted in the preparation of a porous ceramic material with a foam slurry. A type of the surfactant could affect gas-liquid-solid distribution characteristics. In some embodiments of the present disclosure, the surfactant is beneficial for enhancing the uniform dispersion of the micro-nano bubbles and the mineral powder.

In some embodiments, the gelling agent includes at least one selected from the group consisting of carboxymethyl cellulose, a soluble starch, and sodium alginate. The gelling agent adopted in the present disclosure is a commercially-available industrial-grade or analytical-grade product.

In some embodiments, the curing agent includes at least one selected from the group consisting of polyvinyl alcohol, polyvinyl ether, an isobutylene-maleic anhydride copolymer, and a polyacrylate. The curing agent adopted in the present disclosure is a commercially-available industrial-grade or analytical-grade product. In some embodiments of the present disclosure, when types of the gelling agent and the curing agent are selected, interfacial tensions among a gas phase, a liquid phase, and a solid phase could be controlled, such that micro-nano bubbles could be stably and uniformly dispersed in the slurry before the aggregating, the growing, or the dissipating until a green body is cured.

In some embodiments, the mineral powder has a particle size of 400 mesh to 1,000 mesh, an Al₂O₃ content of 10 wt% to 44 wt%, and an SiO₂ content of 15 wt% to 60 wt%. In some embodiments, the mineral powder includes at least one selected from the group consisting of coal gangue, coal slime, red mud, lithium slag, kaolin, mullite, feldspar, quartz, a copper tailing, an iron tailing, and a lead-zinc tailing.

In some embodiments, a mass ratio of the gelling agent, the surfactant, and the water is in a range of (0.005-0.03) : (0.002-0.015) : 1. Amounts of the gelling agent and the surfactant affect the dispersion effect for bubbles and a foam. If a content of the gelling agent is too high and/or a content of the surfactant is too low, a foaming effect will be affected, resulting in low porosity of a ceramic. If the content of the surfactant is too high, large bubbles are easily formed and tend to aggregate, making it impossible to create the micro-nano bubbles and uniformly-dispersed micro-nano pores and resulting in low strength of the porous ceramic. If the content of the gelling agent is too low, it is difficult to steadily maintain the micro-nano pores. Before being added, the gelling agent and the surfactant of the present disclosure each are fully dissolved with an appropriate amount of water in advance.

In some embodiments, a mass ratio of the mineral powder to the micro-nano gel foam is in a range of 0.6 : 1 to 1.2 : 1. A mass of the mineral powder mainly affects a density and porosity of the ceramic. If a proportion of the mineral powder is too large, a resulting porous ceramic has a low porosity, a high density, and non-uniform and insufficient pores, resulting in poor thermal insulation and sound insulation properties. If the proportion of the mineral powder is too small, a structure easily collapses and is not easily shaped during a curing process, and the resulting porous ceramic undergoes weak pore wall-solid phase connection and exhibits a low strength.

In some embodiments, a mass ratio of the curing agent to the slurry-gel foam is in a range of 0.06 : 1 to 0.30 : 1. If a proportion of the curing agent is too large, micro-nano pore structures will be destroyed and a cost will be greatly increased. If the proportion of the curing agent is too small, the fluidity and stability of a slurry will deteriorate during injection molding, a slurry is prone to agglomeration or precipitation, and defects will be easily formed after the green body is demolded. An amount of the curing agent is calculated based on a dry mass.

In some embodiments, the curing is conducted at a temperature of 30 °C to 80 °C for 8 hours to 24 hours.

In some embodiments, the drying is conducted at a temperature of 100 °C to 120 °C for 1 hour to 3 hours.

In some embodiments, the sintering is conducted at a temperature of 1,250 °C to 1,400 °C for 0.5 hours to 2 hours.

The gelling agent involved in the present disclosure is added in a form of a solution. The gelling agent and deionized water are mixed in a mass ratio of (0.005-0.03) : 1 while magnetically stirring in a water bath to prepare a homogeneous solution.

The surfactant involved in the present disclosure is added in a form of a solution. The surfactant and deionized water are mixed in a mass ratio of (0.001-0.02) : 1 while magnetically stirring in a water bath to prepare the homogeneous solution.

The curing agent involved in the present disclosure is added in a form of a solution. The curing agent and deionized water are mixed in a mass ratio of (0.0125-0.04) : 1 while magnetically stirring in a water bath to prepare the homogeneous solution.

The magnetic stirring in the water bath mentioned in the present disclosure is conducted at a temperature of 30 °C to 45 °C and a stirring speed of 200 revolutions/minute to 500 revolutions/minute.

Compared with the prior art, some embodiments of the present disclosure have the following positive effects.
(1) In the present disclosure, a micro-nano gel foam is produced by a micro-nano bubble generator, which enhances uniform dispersion of fine bubbles in a high-viscosity slurry and further refines and homogenizes pores in a produced porous ceramic. The preparation of a micro-nano porous ceramic by the micro-nano bubble generator overcomes limitations that the existing slurry foaming process requires high surfactant consumption and results in small porosity due to a high solid content, and reduces the surfactant consumption.
(2) The present disclosure adopts the micro-nano gel foam as a base fluid, which is suitable for a selection of various mineral powders and demonstrates excellent universality.
(3) The porous ceramic prepared by the present disclosure has characteristics such as fine and uniform pores, a low weight, and a high compressive strength. The porous ceramic has a pore size of 0.5 μm to 23 μm, a density of 0.41 g/cm3 to 0.67 g/cm3, and a compressive strength of 16.3 MPa to 19.1 MPa.
(4) A method for preparing the porous ceramic in the present disclosure involves a simple process flow that is easy to implement, and meets the needs of industrial production.

In summary, in a method for preparing a porous ceramic material provided in the present disclosure, a pore structure is adjusted by changing a foaming mode. The method involves a short process flow that is easy to implement, and could lead to a porous ceramic material with fine and uniform pores, a low weight, and a high compressive strength.

### BRIEF DESCRIPTION OF THE DRAWINGS

FIG. 1 shows a scanning electron microscopy (SEM) image of a micro-nano porous ceramic prepared in Example 1; and

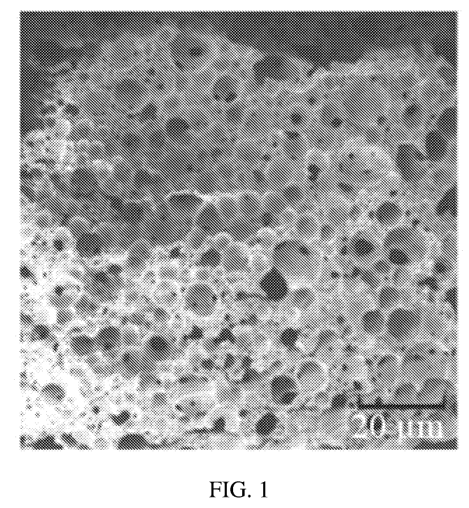

FIG. 2 shows a comparison diagram of a micro-nano gel foam prepared in Example 1 and bubbling in water.

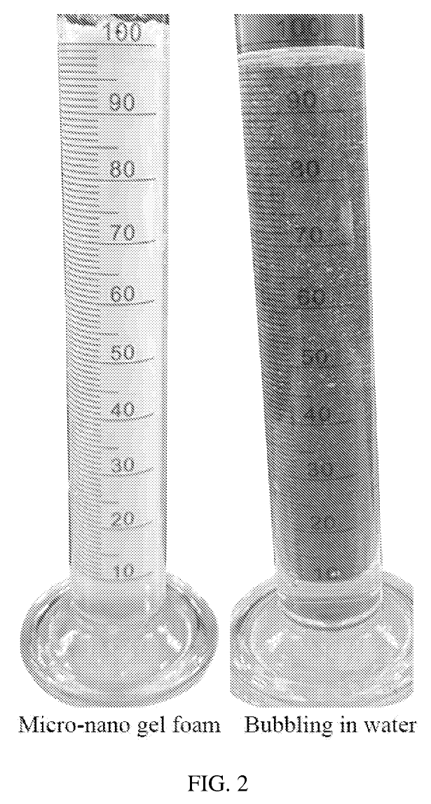

### DETAILED DESCRIPTION OF THE EMBODIMENTS

The content of the present disclosure is further described in detail below in conjunction with specific examples, but the scope of the claims is not limited thereto.

In the following specific examples:

A gelling agent, a surfactant, and a curing agent are industrial-grade or analytical-grade products.

### Example 1

Step 1: Carboxymethyl cellulose as a gelling agent was added to deionized water, and magnetic stirring was conducted in a water bath to prepare a carboxymethyl cellulose-dispersed homogeneous solution for later use. A mass ratio of the carboxymethyl cellulose to the deionized water was 0.015 : 1.

Step 2: Cetyltrimethylammonium bromide as a surfactant was added to deionized water, and magnetic stirring was conducted in a water bath to prepare a cetyltrimethylammonium bromide-dispersed homogeneous solution for later use. A mass ratio of the cetyltrimethylammonium bromide to the deionized water was 0.001 : 1.

Step 3: Polyvinyl alcohol as a curing agent was added to deionized water, and magnetic stirring was conducted in a water bath to prepare a polyvinyl alcohol-dispersed homogeneous solution for later use. A mass ratio of the polyvinyl alcohol to the deionized water was 0.0125 : 1.

Step 4: According to a mass ratio of the carboxymethyl cellulose, the cetyltrimethylammonium bromide, and the deionized water (total water amount) being 0.008 : 0.002 : 1, the carboxymethyl cellulose-dispersed homogeneous solution, the cetyltrimethylammonium bromide-dispersed homogeneous solution, and an appropriate amount of deionized water were mixed to produce an aqueous solution including the gelling agent and the surfactant. The aqueous solution including the gelling agent and the surfactant was fed into a micro-nano bubble generator, subjected to circularly flow at a rate of 10 liters/minute for 5 minutes under aeration with a gas flow rate of 100 millilitres/minute, and then ejected to produce a micro-nano gel foam.

Step 5: A coal gangue powder and the micro-nano gel foam were mixed in a mass ratio of 0.6 : 1, and stirred by a high-speed stirrer at 1,400 revolutions/minute for 10 minutes to produce a slurry-gel foam. The coal gangue powder had an Al₂O₃ content of 39 wt%, an SiO₂ content of 50 wt%, an additional component content of 11 wt%, and an average particle size of 600 mesh.

Step 6: The polyvinyl alcohol-dispersed homogeneous solution was added to the slurry-gel foam, and high-speed shear stirring was conducted at 1,200 revolutions/minute for 15 minutes to produce a stabilized slurry-gel foam. A mass ratio of the polyvinyl alcohol (based on a dry mass) to the slurry-gel foam was 0.06 : 1.

Step 7: The stabilized slurry-gel foam was injected into a mold, cured at 60 °C for 12 hours, and demolded to produce a porous green body.

Step 8: The porous green body was dried at 100 °C for 2 hours and sintered at 1,400 °C for 0.5 hours to produce a porous ceramic with micro-nano pores.

The porous ceramic with micro-nano pores had a pore size of 0.9 μm to 25 μm, a density of 0.48 g/cm³, and a compressive strength of 19.1 MPa.

### Example 2

Step 1: Carboxymethyl cellulose as a gelling agent was added to deionized water, and magnetic stirring was conducted in a water bath to prepare a carboxymethyl cellulose-dispersed homogeneous solution for later use. A mass ratio of the carboxymethyl cellulose to the deionized water was 0.02 : 1.

Step 2: Dodecylamine as a surfactant was added to deionized water, and magnetic stirring was conducted in a water bath to prepare a dodecylamine-dispersed homogeneous solution for later use. A mass ratio of the dodecylamine to the deionized water was 0.0015 : 1.

Step 3: Polyacrylate as a curing agent was added to deionized water, and magnetic stirring was conducted in a water bath to prepare a polyacrylate-dispersed homogeneous solution for later use. A mass ratio of the polyacrylate to the deionized water was 0.02 : 1.

Step 4: According to a mass ratio of the carboxymethyl cellulose, the dodecylamine, and the deionized water (total water amount) being 0.008 : 0.002 : 1, the carboxymethyl cellulose-dispersed homogeneous solution, the dodecylamine-dispersed homogeneous solution, and an appropriate amount of deionized water were mixed to produce an aqueous solution including the gelling agent and the surfactant. The aqueous solution including the gelling agent and the surfactant was fed into a micro-nano bubble generator, subjected to circularly flow at a rate of 15 liters/minute for 5 minutes under aeration with a gas flow rate of 200 millilitres/minute, and then ejected to produce a micro-nano gel foam.

Step 5: A lithium slag powder and the micro-nano gel foam were mixed in a mass ratio of 0.6 : 1, and stirred by a high-speed stirrer at 1,400 revolutions/minute for 10 minutes to produce a slurry-gel foam. The lithium slag powder had an Al₂O₃ content of 21 wt%, an SiO₂ content of 57 wt%, an additional component content of 22 wt%, and an average particle size of 700 mesh.

Step 6: The polyacrylate-dispersed homogeneous solution was added to the slurry-gel foam, and high-speed shear stirring was conducted at 1,200 revolutions/minute for 15 minutes to produce a stabilized slurry-gel foam. A mass ratio of the polyacrylate (based on a dry mass) to the slurry-gel foam was 0.08 : 1.

Step 7: The stabilized slurry-gel foam was injected into a mold, cured at 60 °C for 12 hours, and demolded to produce a porous green body.

Step 8: The porous green body was dried at 100 °C for 2 hours and sintered at 1,250 °C for 0.5 hours to produce a porous ceramic with micro-nano pores.

The porous ceramic with micro-nano pores had a pore size of 1 μm to 23 μm, a density of 0.41 g/cm³, and a compressive strength of 16.3 MPa.

### Example 3

Step 1: Carboxymethyl cellulose as a gelling agent was added to deionized water, and magnetic stirring was conducted in a water bath to prepare a carboxymethyl cellulose-dispersed homogeneous solution for later use. A mass ratio of the carboxymethyl cellulose to the deionized water was 0.03 : 1.

Step 2: Tea saponin as a surfactant was added to deionized water, and magnetic stirring was conducted in a water bath to prepare a tea saponin-dispersed homogeneous solution for later use. A mass ratio of the tea saponin to the deionized water was 0.02 : 1.

Step 3: Polyvinyl alcohol as a curing agent was added to deionized water, and magnetic stirring was conducted in a water bath to prepare a polyvinyl alcohol-dispersed homogeneous solution for later use. A mass ratio of the polyvinyl alcohol to the deionized water was 0.04 : 1.

Step 4: According to a mass ratio of the carboxymethyl cellulose, the tea saponin, and the deionized water (total water amount) being 0.008 : 0.002 : 1, the carboxymethyl cellulose-dispersed homogeneous solution, the tea saponin-dispersed homogeneous solution, and an appropriate amount of deionized water were mixed to produce an aqueous solution including the gelling agent and the surfactant. The aqueous solution including the gelling agent and the surfactant was fed into a micro-nano bubble generator, subjected to circularly flow at a rate of 8 liters/minute for 10 minutes under aeration with a gas flow rate of 250 millilitres/minute, and then ejected to produce a micro-nano gel foam.

Step 5: A coal slime powder and the micro-nano gel foam were mixed in a mass ratio of 0.6 : 1, and stirred by a high-speed stirrer at 1,400 revolutions/minute for 30 minutes to produce a slurry-gel foam. The coal slime powder had an Al₂O₃ content of 25 wt%, an SiO₂ content of 47 wt%, an additional component content of 28 wt%, and an average particle size of 1,000 mesh.

Step 6: The polyvinyl alcohol-dispersed homogeneous solution was added to the slurry-gel foam, and high-speed shear stirring was conducted at 1,200 revolutions/minute for 15 minutes to produce a stabilized slurry-gel foam. A mass ratio of the polyvinyl alcohol to the slurry-gel foam was 0.08 : 1.

Step 7: The stabilized slurry-gel foam was injected into a mold, cured at 60 °C for 12 hours, and demolded to produce a porous green body.

Step 8: The porous green body was dried at 100 °C for 2 hours and sintered at 1,400 °C for 0.5 hours to produce a porous ceramic with micro-nano pores.

The porous ceramic with micro-nano pores had a pore size of 0.5 μm to 17 μm, a density of 0.67 g/cm³, and a compressive strength of 17.7 MPa.

### Comparative Example 1

The operating conditions and implementing steps in this comparative example were the same as those in Example 1, except that, in step 4, a conventional stirrer was used instead of the micro-nano bubble generator, and high-speed stirring was conducted at 1,400 revolutions/minute for 10 minutes to produce a gel foam. A porous ceramic with micro-nano pores had a pore size of 93 μm to 463 μm, a density of 0.78 g/cm³, and a compressive strength of 5.47 MPa. Bubbles formed by the conventional stirrer have a large diameter and a low density, such that the porous ceramic with micro-nano pores has oversized pores unevenly distributed, and exhibits a relatively low compressive strength.

### Comparative Example 2

The operating conditions and implementing steps in this comparative example were the same as those in Example 2, except that, in step 4, an amount of the gelling agent was reduced, and a mass ratio of carboxymethyl cellulose, dodecylamine, and deionized water was 0.002 : 0.002 : 1. A porous ceramic with micro-nano pores had a pore size of 70 μm to 325 μm, a density of 0.70 g/cm³, and a compressive strength of 7.31 MPa. Due to a too-small proportion of the gelling agent, it is difficult to maintain stability of micro-nano bubbles during a curing process, some micro-nano pore structures collapse, and pores are unevenly distributed.

### Comparative Example 3

The operating conditions and implementing steps in this comparative example were the same as those in Example 3, except that a step and a manner for adding the curing agent were changed, and the gelling agent, the surfactant, and the curing agent were simultaneously added to water to prepare a mixed homogeneous solution. A porous ceramic with micro-nano pores had a pore size of 125 μm to 645 μm, a density of 0.59 g/cm³, and a compressive strength of 3.86 MPa. The simultaneous mixing of three agents adversely affects a gelling effect of a micro-nano foam slurry, makes it fail to form a uniform and stable gel network, results in uneven pore wall thicknesses, is not beneficial for formation of a porous ceramic green body, and significantly reduces the strength.

What is claimed is:

1. A method for preparing a porous ceramic with micro-nano pores, comprising the following steps:
1) mixing a gelling agent, a surfactant, and water while stirring to produce a homogeneous solution;
2) feeding the homogeneous solution into a micro-nano bubble generator, subjecting the homogeneous solution to circularly flow under aeration, and conducting ejection to produce a micro-nano gel foam, wherein a rate of the circular flow is 2 liters/minute to 20 liters/minute, and the aeration is conducted for 5 minutes to 10 minutes with a gas flow rate of 100 millilitres/minute to 250 millilitres/minute;
3) adding a mineral powder to the micro-nano gel foam, stirring for 10 minutes to 30 minutes at a speed of 1,000 revolutions/minute to 1,400 revolutions/minute to produce a slurry-gel foam, adding a curing agent to the slurry-gel foam, and stirring for 15 minutes to 30 minutes at a high speed of 1,000 revolutions/minute to 1,400 revolutions/minute to produce a stabilized slurry-gel foam; and
4) subjecting the stabilized slurry-gel foam to injection molding, curing, demolding, drying, and sintering in sequence to produce the porous ceramic.

2. The method according to claim 1, wherein
the gelling agent comprises at least one selected from the group consisting of carboxymethyl cellulose, a soluble starch, and sodium alginate;
and/or
the surfactant comprises at least one selected from the group consisting of sodium dodecyl sulfonate, dodecylamine, cetyltrimethylammonium bromide, and a plant protein;
and/or
the curing agent comprises at least one selected from the group consisting of polyvinyl alcohol, polyvinyl ether, an isobutylene-maleic anhydride copolymer, and a polyacrylate;
and/or
the mineral powder has a particle size of 400 mesh to 1,000 mesh, an Al₂O₃ content of 10 wt% to 44 wt%, and an SiO₂ content of 15 wt% to 60 wt%.

3. The method according to claim 1, wherein a mass ratio of the gelling agent, the surfactant, and the water is in a range of (0.005-0.03) : (0.002-0.015) : 1.

4. The method according to claim 1, wherein a mass ratio of the mineral powder to the micro-nano gel foam is in a range of 0.6 : 1 to 1.2 : 1.

5. The method according to claim 1, wherein a mass ratio of the curing agent to the slurry-gel foam is in a range of 0.06 : 1 to 0.30 : 1.

6. The method according to claim 2, wherein the mineral powder comprises at least one selected from the group consisting of coal gangue, coal slime, red mud, lithium slag, kaolin, mullite, feldspar, quartz, a copper tailing, an iron tailing, and a lead-zinc tailing.

7. The method according to claim 1, wherein the curing is conducted at a temperature of 30°C to 80°C for 8 hours to 24 hours.

8. The method according to claim 1, wherein the drying is conducted at a temperature of 100°C to 120°C for 1 hour to 3 hours.

9. The method according to claim 1, wherein the sintering is conducted at a temperature of 1,250°C to 1,400°C for 0.5 hours to 2 hours.

10. The method according to claim 2, wherein a mass ratio of the gelling agent, the surfactant, and the water is in a range of (0.005-0.03) : (0.002-0.015) : 1.

11. The method according to claim 2, wherein a mass ratio of the mineral powder to the micro-nano gel foam is in a range of 0.6 : 1 to 1.2 : 1.

12. The method according to claim 2, wherein a mass ratio of the curing agent to the slurry-gel foam is in a range of 0.06 : 1 to 0.30 : 1.
